(19) United States
(12) Patent Application Publication
(10) Pub. No.: US 2006/0198327 A1
(43) Pub. Date: Sep. 7, 2006

(54) Selection method for data communication between base station and transponders

(75) Inventor: Ulrich Friedrich, Ellhofen (DE)

Correspondence Address: BIRCH STEWART KOLASCH & BIRCH, PO BOX 747, FALLS CHURCH, VA, 22040-0747, US

(73) Assignee: ATMEL GERMANY GMBH, Heilbronn (DE)

(21) Appl. No.: 11/366,483

(22) Filed: Mar. 3, 2006

(30) Foreign Application Priority Data
Mar. 3, 2005 (DE) DE102005009765.0

(51) Int. Cl. H04B 7/005; H04Q 7/00

(52) U.S. Cl. 370/278; 370/329

(57) ABSTRACT

A selection method for selecting at least one transponder located in the response area of a base station, which are linked to one another by a wireless bidirectional data communication path, in which method the base station transmits an electromagnetic carrier signal, which has at least one arbitration symbol, wherein each arbitration symbol has a query segment in which data are encoded by the base station, and has a response segment that can be used by the transponder for coding and modulation of information for return data transmission, wherein the selection of a transponder takes place on the basis of distinguishable points in time in the time segment for the modulation that are produced from a reference time which is derived from the arbitration symbol itself.

This nonprovisional application claims priority under 35 U.S.C. § 119(a) on German Patent Application No. DE 102005009765, which was filed in Germany on Mar. 3, 2005, and which is herein incorporated by reference.

### BACKGROUND OF THE INVENTION

1. Field of the Invention

The present invention relates to a selection method for data communication between a base station and transponders.

2. Description of the Background Art

The invention resides in the field of transponder technology and more particularly in the field of contactless communication for the purposes of identification. Although applicable in principle to any desired communication systems, the present invention and the problems it was designed to solve are explained below with respect to RFID communication systems and their applications. RFID stands for “Radio Frequency Identification.” For general background on RFID technology, please refer to the “RFID Handbuch” by Klaus Finkenzeller, Hanser Verlag, third revised edition, 2002, which has been published in English by John Wiley & Sons.

In the case of transponders, an electromagnetic signal sent out by a base station is received and demodulated by the transponder. In this context, a distinction is made between active, semi-passive, and passive transponders, depending on how their energy supply is implemented. In contrast to active transponders, passive transponders have no energy supply of their own, so the energy required in the transponder for demodulation and decoding of the received electromagnetic signal must be extracted from the electromagnetic signal transmitted by the base station. In addition to this unidirectional transfer of energy, bidirectional data communication between the base station and transponder typically also takes place; this is described in more detail below.

In most UHF and microwave based RFID systems or sensor systems, bidirectional data communication between base station and transponder is first initiated by the base station in that the base station transmits a query signal (command, data request) to the various transponders located in the vicinity of the base station. The transponder or transponders participating in the data communication typically react to this query with a response signal (response). Such RFID systems are also called master/slave systems. In master/slave-based RFID systems, the data communication between base station and transponder is controlled by the base station. The foundation for bidirectional data transmission between the base station and transponder is what is referred to as a communication protocol, which defines control information for the data communication in addition to the data transmission to be transmitted. A generic RFID communication protocol for data communication between base station and transponders is described in DE 101 38 217 A1, which corresponds to U.S. Publication No. 2003133435, which is incorporated herein by reference.

One method used for return data transmission (return link) from the transponder back to the base station is known as the backscatter technique. In this method, first the base station emits high-frequency electromagnetic carrier signals, which are received and processed by the transmitting and receiving device in the transponder. In addition, the received carrier signals are modulated with a customary modulation method and are scattered back using the backscatter cross-section of the transponder's transmit/receive antenna. A known RFID communication system in which return data transmission is accomplished using the backscatter method is described in EP 750 200 B1, which corresponds to U.S. Pat. No. 5,649,295.

The operation of an RFID system, typically one base station, frequently also called a reader, has associated with it a plurality of transponders (or tags or labels), which may be located in the response area of the base station at the same time. Now, to make it possible for data to be transmitted from a number of individual transponders within the range (response area) of the base station back to the base station, a process known as a multiple access method exists. In this method, the existing channel capacity is assigned to the individual transponders such that data transmission to the base station can be carried out by multiple transponders without mutual interference (collision) occurring. Technical implementation of multiple access in RFID systems places a number of demands on the transponders and base station, since it is necessary to reliably prevent the data returned by the transponders from colliding in the receiver of the base station and thereby becoming unreadable, without a significant expenditure of time. A wide variety of selection methods for master/slave-based RFID systems is known in this regard, with the best-known and preferred method being the anticollision method, since it has an access protocol which permits almost interference-free execution of multiple access.

When an anticollision method (selection method) is based on an arbitration (assignment), during the course of which all transponders or even groups of transponders are selected sequentially, a given transponder is provided by the base station with an arbitration symbol (query or acknowledgement symbol) over the forward link. This arbitration can be implemented in the half-duplex method or in full-duplex, although in general the full-duplex method is advantageous on account of the higher speed realized with it.

FIGS. 6a-c show a structure of an arbitration symbol for a conventional full-duplex anticollision method. In the full-duplex method, the base station transmits a carrier signal A, which comprises one or more arbitration symbols B of duration T1, to the transponder or transponders. As is evident in FIG. 6a, the arbitration symbol B includes a query segment C of duration T11 and a response segment D of duration T12. Query segment C and response segment D differ from one another by different signal levels Sh, SI, which is to say the query segment C has a low signal level SI and the response segment D has a high signal level Sh. This can be communicated by the base station, for example by switching off the electromagnetic field or by reducing the transmit power. Within the duration T12 of the response segment D, the transponder is capable of transmitting a response signal E back to the base station using the above-described backscatter method.

In the protocol of the data transmission in the arbitration method shown using FIG. 6a-c, the coding in the forward link is accomplished by a different duration T11 of the query segment C, and thus also of the response segment D. The FIGS. 6a-c show the protocol with which a logic “0” (FIG. 6a), a logic “1” (FIG. 6b), and an EOT signal (FIG. 6c) (EOT=End Of Transmission) are transmitted. The point in time Tx of a signal change F between the low logic level (low) and the high logic level (high) defines whether a logic “0”, a logic “1”, or an EOT signal is transmitted in a current frame T1 of an arbitration symbol B. These points in time Tx are predefined in a fixed manner with reference to the applicable frame for the various codings. However, the transponder typically does not yet know these points in time Tx at the beginning of a data communication or of the arbitration method. For this reason, in a master/slave-based RFID system, this data transmission protocol provides for the base station to transmit, prior to the actual data communication, a reference time as reference mark to the transponder or transponders participating in the data communication that provides information on the predefined points in time for a signal change. This reference time Tref is stored by the transponder. The symbols (“0,” “1,” EOT) utilized in the data transmission protocol, which are transmitted from the base station for data communication with the transponder, can then be derived from the reference time by arithmetic derivation.

Arbitration at bit position n begins with a query or acknowledgement signal from the base station, in which the base station communicates to the transponder what value (“0” or “1”) the transponder must have at the relevant bit position n in order to be able to participate further in the arbitration. If this condition is met, the transponder then communicates to the base station the value of the bit position n+1 in the response segment by backscattering using subcarrier modulation. The base station evaluates these backscattered response signals in the frequency range and thereupon transmits to the applicable transponder the next symbol for the next bit position, etc. If the base station transmits a query or acknowledgement signal with the value EOT, this symbol signals the transponder that the end of arbitration has been reached and the transponder or transponders selected up to that point remain active.

In order for the base station to be able to distinguish data transmitted back from the transponder by backscattering from the data transmitted by the base station in the forward link, the sidebands (or subcarriers or subsidiary bands) created in the return link by the backscattering are used here. The base station thus receives the carrier signal backscattered by backscattering and evaluates the corresponding sidebands by evaluating their amplitudes and frequencies.

However, this method has several disadvantages:

Different approved frequency bands for data communication exist in different countries on the basis of the HF/RF regulations applicable there. These regulations prescribe, among other things, that the sidebands produced by backscattering must lie within a limited frequency range, which can be defined in a country-specific manner, for example in order to avoid adversely affecting adjacent usable frequency bands. Consequently, it is necessary to guarantee the usage of the sidebands within very tight tolerances. This requires the use of a highly precise oscillator in order to guarantee this requirement over the entire voltage and temperature range of the transponder. However, this entails a relatively high power consumption, which directly results in a correspondingly reduced range for the data communication in the case of passive transponders, for example.

The higher frequency of the two sidebands cannot be an even multiple of the respective lower frequency, as otherwise the harmonics will be more or less equal, and precise determination of the frequency of the sidebands by the base station is no longer possible as a result of multipath propagation and the associated constructive and destructive interference. For this reason, higher oscillator frequencies—typically by a factor of at least three—are necessary. However, this is also accompanied by an increased current consumption by the transponder, which is to be avoided on account of the limited energy in the transponder and on account of the range.

The protocol described above in conjunction with FIG. 6 uses subcarriers of approximately 2.5 MHz. Such high frequencies typically lie outside the allowable bandwidth of many countries such as the European countries and the USA. Since the bandwidth required for transmission of an arbitration symbol in Europe is only approximately 250 KHz, thus 125 KHz for each sideband, the method described above is not currently approved in Europe. An offset in the kilohertz range (up to 125 KHz) is permitted, but would significantly prolong the arbitration symbol, which would then undesirably lead to lower data transmission rates. Moreover, this subcarrier frequency would have to be adjustable in order to be usable at other bandwidths as well.

In order to meet HF regulations and/or achieve high data transmission rates (BER=bit error rate), it is advantageous for a long reference time to be chosen. However, this results in significant modulation losses, which undesirably results in a reduction in the achievable range of the data communication between base station and transponder.

In addition, the data transmission rate is also relatively low on account of the HF regulations applicable in Europe. Depending on the quality of the base station, several periods of a subcarrier are necessary for analysis in the frequency range in order to be able to reliably recognize the frequency of the subcarrier. However, this significantly reduces the data transmission rate, and thus the data transmission speed. Since the highest subcarrier frequency presently approved in Europe is 125 KHz, already five periods require a minimum response time of 40 μsec. Such a long response time is too long for current RFID systems. Present-day RFID systems, which make use of UHF carrier signals, have a data transmission speed of up to 40 kbit/sec, which corresponds to a bit time of approximately 25 msec for the response. Added to this is the fact that the lower of the two subcarrier frequencies cannot be an integer multiple of the respective higher subcarrier frequency in order to exclude shared sidebands, further reducing the maximum data transmission rate on the whole.

The aforementioned requirements of low current consumption, low oscillator frequency, and large oscillator tolerances cannot be satisfactorily met through the use of subcarrier modulation.

### SUMMARY OF THE INVENTION

It is therefore an object of the present invention to provide data communication between a base station and transponder in which an optimal data transmission rate is ensured with the utilization of specified sidebands. A further object provides for at least two mutually distinguishable signals to be transmitted back by the transponder after reception and analysis of the query signal. A further object is to provide an easy-to-implement data communication between a base station and transponder that is not only usable worldwide but also minimizes the current consumption of the transponder while preserving the structure of the data communication protocol in particular.

According thereto, a selection method is provided for selecting at least one transponder located in a response area of a base station, which are linked to one another by a wireless bidirectional data communication path, in which method the base station transmits an electromagnetic carrier signal, which has at least one arbitration symbol, wherein each arbitration symbol has a query segment in which data are encoded by the base station, and has a response segment which can be used by the transponder for coding and modulation of information for return data transmission, wherein the selection of a transponder takes place on the basis of distinguishable points in time in the time segment for the modulation that are produced from a reference time which is derived from the arbitration symbol itself.

The modulation and analysis of information from the transponder, coded in the response segment, can take place in a time segment, which is very simple to implement.

Thus, it is possible to transmit at least two mutually distinguishable signals from the transponder back to the base station following reception and analysis of the query signal, without thereby incurring the aforementioned disadvantages of the conventional methods. In particular, the structure of the data transmission is preserved; only the provision of the information in the response segment of the transmitted arbitration symbol changes. In this way, an easily implemented solution is found, which is not only usable worldwide as it offers an adaptive option for meeting different HF regulations, but also minimizes the current consumption required in the transponder.

In an embodiment of the present invention, it is provided that, following the query segment, two or more mutually distinguishable reference points in time at which the transponder changes the modulation in the return link according to the value of the n+1th value. In this regard, the arbitration symbol is divided into a number of segments of equal size, each of which is a multiple of the duration of the transmitted arbitration symbol, but is shorter than the time for marking an EOT signal. Subsequent thereto, the sequence of modulation changes can then be repeated. This division is predefined by a reference time, for example transmitted in the header of the communication protocol. Overall, this results in better bit error rates (BER).

Through appropriate choice of the reference duration and the duration of a time frame, it is possible to adapt the transmission rate to the transmission conditions within a certain range.

In order to determine the times of the modulation change between the query segment and response segment, which is to say to determine the signal change between low signal level and high signal level, and vice versa, a very elegant and very simple inventive method is proposed. So that the transponder reliably detects whether the data signal transmitted from the base station is a “0,” a “1,” or an EOT, the transponder must be able to derive from the reference time the corresponding three, preferably equal in size, time segments for a “0,” a “1,” or an EOT. In the simplest case, this is accomplished by dividing a time frame by three. Division by three is very difficult to implement in circuit design or also in software design, however. The present invention divides the reference time specified by the base station by, for example, four in order to obtain four equal time segments. Of these four segments, only three are used, for example the first or last three, in order to thereby obtain three equal segments which together correspond to the duration of a time frame. Division of the time reference duration into four equal segments can be accomplished by a multiplexer in a very simple manner.

Under the first precondition that the time reference is longer than the time frame for an arbitration symbol, it is thus possible to derive three equal time segments of a time frame through appropriate choice of the time reference and the duration of a time frame. The particular advantage here is that equal respective sidebands of the frequency spectrum are thus present for a “0” and a “1”. This significantly simplifies the design of the transponder modulation for return data transmission as well as the base station analysis. Overall, this results in a significantly lower current consumption for the oscillator internal to the transponder, which is noticeable as a significantly increased range.

The unused fourth segment of the time reference can be used, for example, as an error control layer (parity bit or CRC), and thus can have an additional functionality. While this entails a lower data transmission rate, it also increases functionality.

In an embodiment of the present invention, modulation of information intended for return transmission and/or its analysis by the base station can take place in the time segment.

In another embodiment, the query segment and response segment can be defined by different amplitudes of the carrier signal, wherein the query segment has a first logic level and the response segment has a second logic level of the carrier signal. The distinguishable points in time are thus typically defined by signal change between adjacent query segments and response segments.

In yet another embodiment, the information encoded in the response segment can be transmitted back to the base station in the full-duplex method, in particular using the backscatter method.

A further embodiment provides that the method can also be used for selecting groups of transponders in addition to selecting individual transponders.

In another embodiment, the reference time is derived from the duration of an arbitration signal, for example from a frame of the carrier signal. Additionally or alternatively, provision can also be made that the reference time can be derived from the duration of another symbol of the carrier signal.

The modulation points in time can be calculated directly from the reference time through binary division of the reference time into equal time segments or by binary multiplication of the reference time. In this regard, a different number of time segments and/or a different multiple of the time segments can be provided for different modulation points in time.

Further, three equal time segments can be provided for coding two distinguishable modulation points in time. Each time segment here corresponds to the reference time itself or to a binary multiple of the reference time. Three equal time segments, which are derived in accordance with the invention by division from the reference time, are then provided for coding two different modulation points in time.

Another embodiment provides that the reference time and the duration of an arbitration symbol can be predefined by the base station such that, by dividing the reference time into four equal time segments, three of these time segments are usable for coding the two distinguishable modulation points in time.

The protocol of the data communication can be structured such that the carrier signal has multiple arbitration symbols, which preferably all have an equal symbol duration.

In another embodiment, a master/slave-based data communication between the base station and the transponder is provided in which the base station transmits electromagnetic carrier signals onto which information packets are modulated, wherein each information packet has a header section, a middle section, and a trailer section, wherein the header section is provided for controlling the data communication. The reference time can be transmitted in the header section in this connection.

A further embodiment provides that the modulation can be controlled by a counter, in particular by an analog time measurement unit. The counter is preferably designed to determine the end point of the modulation following the beginning of the modulation.

Further, the counter can only be active at the point in time of modulation for return data transmission. In particular, the counter is switched inactive once the end time point is reached.

The counter can also begin to count with a fixed, defined start time. In this regard, the current count state of the counter can be continuously compared to additional reference durations which define the modulation time points, with the modulation being changed when the current count state of the counter reaches one of the additional reference durations.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a basic structure (protocol) of an information packet of a data communication between base station and transponder;

FIGS. 2a-c illustrate the structure of an arbitration symbol transmitted by the base station for the purpose of illustrating the inventive coding by means of equal time segments;

FIG. 3a-c show a principle for illustrating the generation of three equal segments from a reference time duration;

FIG. 4 is a signal-time diagram illustrating an example embodiment of the transmission of an item of information in the arbitration symbol;

FIG. 5 is a block diagram showing the structure of a transponder having a control device and modulation device for carrying out the method according to the invention; and

FIG. 6 shows an arbitration protocol for an arbitration symbol transmitted in full-duplex.

### DETAILED DESCRIPTION

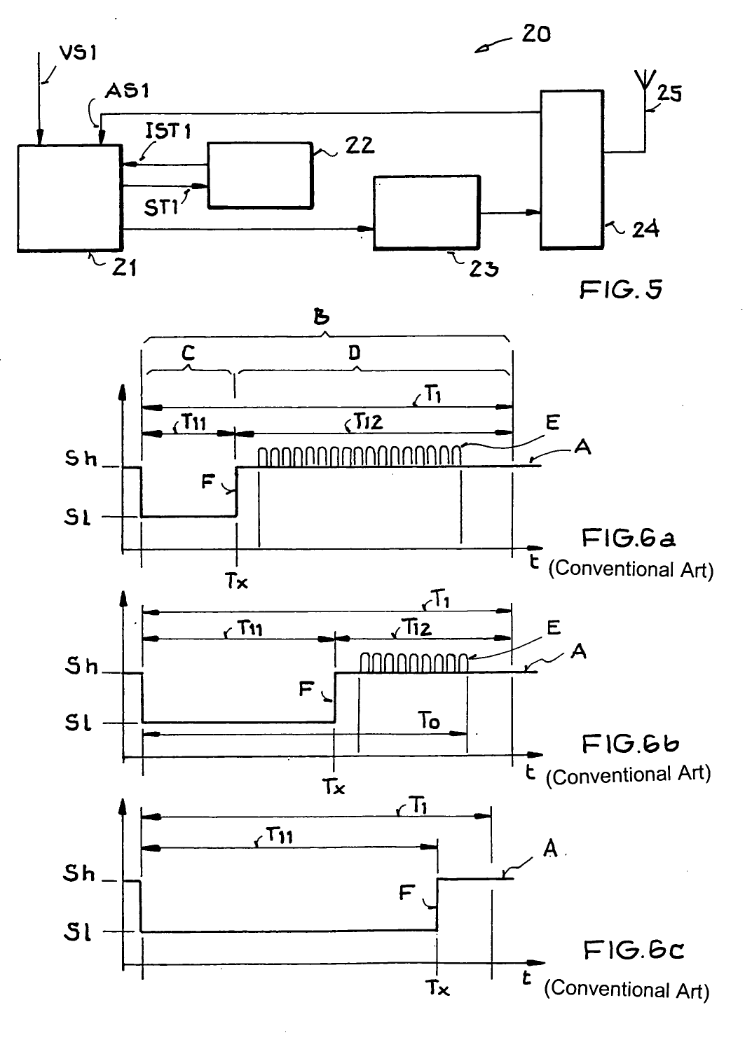

In the drawings, like or functionally like elements, data, and signals are identified with the same reference labels, unless otherwise specified. The representations in FIGS. 1-4, and 6 each relate to a time sequence of a given data communication.

Firstly, FIG. 1 shows a basic structure of an information packet 1 such as is used for data communication between a base station and a transponder.

The information packet 1 has a header section 2, a middle section 3, and a trailer section 4. The number of data items to be transmitted and their identification, and in many applications control information as well, are defined by the header section 2. In particular, the header section 2 defines reference times that are used for further data processing in the middle section 3 or data field 5. The middle section 3 contains the relevant data to be transmitted, wherein the middle section 3 can also preferably be used for purposes of control in some applications. The middle section 3 typically includes a data field 5 and an error control field 6 immediately following the data field 5. Coded data symbols are transmitted in the middle section 3. The data communication is protected by error control mechanisms such as, for example, a CRC error control field 6 or parity bits. The content of the trailer section 4 indicates to the receiver of this information packet 1 that it has ended. For example, the trailer section 4 can have two of what are known as EOT symbols 7 (EOT=End Of Transmission).

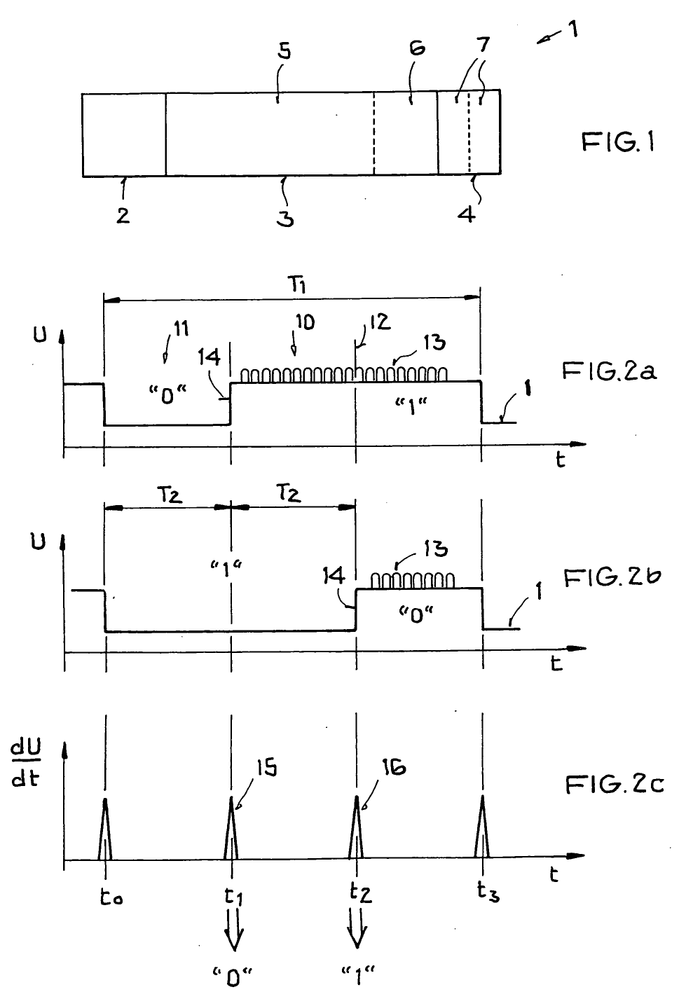

FIG. 2 shows the structure of an arbitration symbol transmitted by the base station for the purpose of illustrating the inventive coding by equal time segments.

Shown in FIG. 2 are two arbitration symbols 10 of duration T1 containing a query segment 11 and a response segment 12. In this context, an arbitration symbol 10 for transmission of a “0” is shown in FIG. 2a, and an arbitration symbol 10 for transmission of a “1” is shown in FIG. 2b. For coding and thus for transmission of the data (“0”, “1”), an arbitration symbol 10 is divided into three equal time segments of duration T2. An arbitration symbol containing a “0” differs from an arbitration symbol containing a “1” by query segments 11 of different lengths. A signal change 14 between the query segment 11 and the response segment 12 takes place at the time t1 in the case of a “0” to be transmitted, and at the time t2 in the case of a “1” to be transmitted, where the duration T2 of the query segment 11 for a “0” to be transmitted is exactly half the size of the time duration 2*T2 for a “1” to be transmitted. FIG. 2(C) shows the time derivative dU/dt of the signal curve of the arbitration signals 10 from FIG. 2(A) and FIG. 2(B). In the case of a “0” to be transmitted, a Dirac impulse 15 results (in the ideal case) at the time t1, and in the case of a “1” to be transmitted, the Dirac impulse takes place at the time t2.

In the response segment 12, response signals 13 are modulated onto the arbitration symbol 10, for example by FSK backscatter modulation of the carrier signal 19 in the response segment 12. In the present example embodiment it is assumed that a “1” is supposed to be transmitted back to the base station through the backscatter-modulated response signal 13 in FIG. 2a, and a “0” is supposed to be transmitted back through the response signal 13 in FIG. 2b.

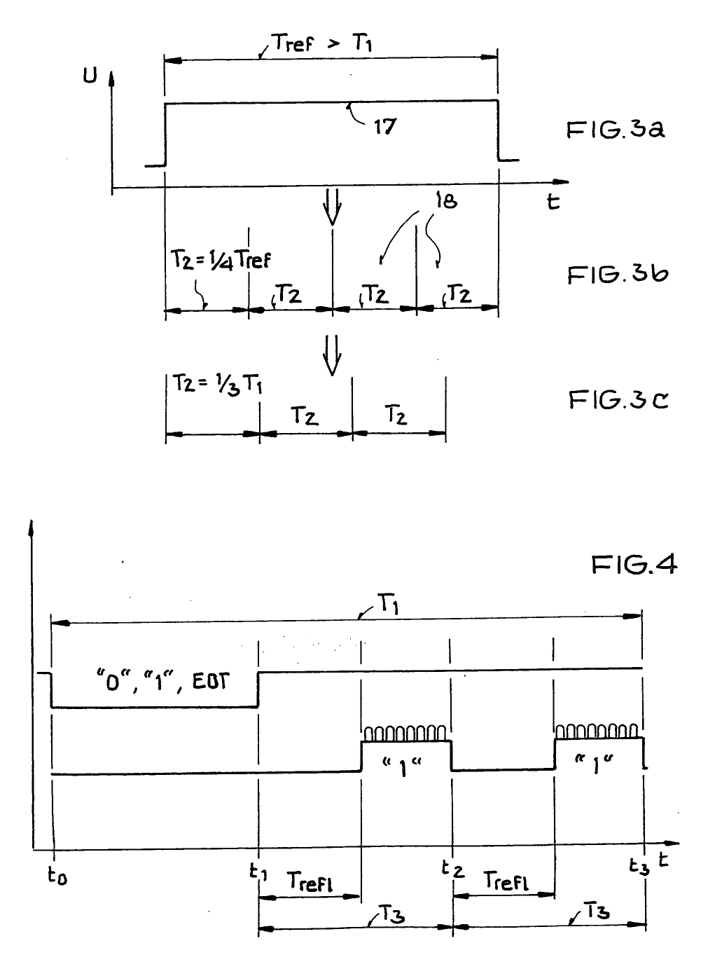

FIG. 3 uses a timing diagram (FIG. 3a-c) to illustrate the principle for the generation of three equal segments 18 from a reference duration. At the start of a data transmission, the base station transmits, for example in the header section of the data communication, a reference mark 17 of duration Tref (see FIG. 3a). The duration Tref is greater than the duration T1 of a frame of an arbitration symbol 10. In one or more steps, this duration Tref is now divided into four equal time segments of the duration T2=¼*Tref, for example by means of a multiplexer (see FIG. 3b). In the next step (see FIG. 3c), three of these segments 18 of duration T2 are selected, and these are now used for the data communication shown on the basis of FIG. 2 in the forward link and return link of the data communication. For each of these segments 18, the condition T2=⅓* T1 is now fulfilled, where T1 represents the duration of an arbitration symbol 10.

The special advantage here is that both the Dirac-type signal 15 at the time t1 and the Dirac-type signal 16 at time t2 have the same sidebands, or in other words, equal sidebands are guaranteed in this way for both a “0” and a “1,” which is very advantageous for the entire frequency spectrum in the baseband, and thus for the data communication as a whole.

The base station thus need only ensure that the following conditions are met for T1, T2 and Tref:
Tref>T1 (1)
T2=¼×Tref (2)
T2=⅓×T1 (3).

Thus, in a very simple but nevertheless very effective and elegant way, three equal sections 18 can be provided that can be employed for a data communication such as is shown in FIG. 2, which uses three equal sections 18 for the coding. The special advantage here is that as a result of the choice of three equal sections, thus in which a signal change can only take place at a transition from one segment to the other segment 18, the transponder need only monitor the corresponding points in time for this change and arrange the return data transmission to correspond therewith. Furthermore, this form of return data transmission is particularly advantageous, especially with respect to the frequency spectrum in the baseband, since equal sidebands are present here in each case.

This type of coding, in which two bits are transmitted simultaneously within one frame of a symbol for transmission, is generally also referred to as three-phase 1 coding.

In order to be able to determine the times for the modulation change as precisely as possible, an enhanced option is also possible, which is explained in detail on the basis of the next example embodiment in FIG. 4. FIG. 4 shows a signal-time diagram to illustrate the transmission of an item of information in the arbitration symbol. The modulation stream of the transponder is represented below the arbitration symbol here. In the example shown in FIG. 4, a piece of information “1” is transmitted back to the base station in the return link twice by the transponder. It would also be possible here for just one piece of information or more than two pieces of information to be transmitted back.

First a reference time Tref is predetermined. This reference time is divided by two or four, for example. This results in different reference times Tref1 and Tref0 corresponding to the values “1” and “0,” respectively. If more values are transmitted, more divisors must be determined accordingly. Once the arbitration symbol has been analyzed by the transponder (“0”, “1”), if the arbitration conditions are met, a counter is enabled, for example. The counter is preloaded by the enable signal in accordance with the value at the position n+1 (ref0, ref1), and then counts to an end mark. At the end mark, the transponder changes the modulation. Once the time duration T3 has elapsed, this process can repeat.

In addition or alternatively, the counter can continuously count up or down. The value of the counter is then compared to the reference mark Tref1 or Tref0 according to the value of the bits at the position n+1. When the counter reaches this value, the modulation is switched. The counter can then be turned off to save power.

FIG. 5 uses a block diagram to show a control device within a transponder for modulation control. The transponder is identified with reference symbol 20 in FIG. 5. The transponder 20 has a control unit 21, a timing controller 22, for example a counter, and a modulator 23, which are arranged inside the transponder 20.

In the receive path, the control unit 21 is typically coupled with the transmitting/receiving antenna 25 through a connecting line and a transmitting/receiving device 24. An arbitration symbol AS1, which contains an encoded item of information in the query segment contained therein, is transmitted to the control unit 21 from the base station, not shown in FIG. 5, through the transmitting/receiving device 24. In an identical fashion, a control unit 20, which is designed as an FSM unit (FSM=finite state machine), is supplied with a comparison value VS1 or a reference value. In the transmit path, the modulator 23 is coupled to the transmitting/receiving antenna 25 through the transmitting/receiving device 24.

In this context, the control unit 21 starts and stops the counter 22 through an appropriate start/stop signal ST1. The counter 22 is typically designed as an up counter, and counts continuously, thus determining a count state that is transmitted to the control unit 21 in the form of an actual value IST1.

By means of the control unit 21 shown in FIG. 5, it is possible to carry out controlled modulation changes in the transponder 20 in the time segment. It is possible for the base station to adapt to the applicable bandwidth requirements by specifying a comparison value VS1, which contains the reference duration Tref.

Although the present invention was described above on the basis of a preferred example embodiment, it is not limited thereto, but can rather be modified in many diverse ways.

In particular, the invention is not limited exclusively to RFID systems, but rather can of course also be extended, for example for item identification. Frequently it is not necessary to uniquely identify individual items. In these cases, it is generally sufficient to be able to rule out the presence of, e.g., a defective item. This is generally also described as non-unique identification. When a transponder is operated in this context, it has the function of a remote sensor. Thus the invention explicitly also relates to such sensors in which a communication is performed to read and write data of a data carrier or sensor. As an example of such a remote sensor application, reference is made to a temperature sensor, a pressure sensor, or the like.

Also, the invention is not applicable only to selection methods in connection with transponder arbitration, but rather can also be used for coding in conventional data communication, insofar as this is reasonable.

The data communication system and method described above were described using the “reader talks first” principle. Naturally, the “tag talks first” principle, in which the base station waits for a query from a transponder (tag), would also be conceivable. However, this principle has a poorer reaction time, so that the “reader talks first” principle is used, especially in modern long-range data communication systems.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A selection method for selecting at least one transponder located in a response area of a base station, which are linked to one another by a wireless bidirectional data communication path, the method comprising the steps of:
transmitting by the base station an electromagnetic carrier signal, which has at least one arbitration symbol, each arbitration symbol having a query segment in which data are encoded by the base station and having a response segment that is used by the transponder for coding and modulation of information for return data transmission; and
selecting a transponder on the basis of distinguishable points in time in the time segment for the modulation that is produced from a reference time, which is derived from the at least one arbitration symbol.

2. The method according to claim 1, wherein the modulation of information intended for return transmission and its analysis by the base station take place in the time segment.

3. The method according to claim 1, wherein the query segment and response segment are defined by different amplitudes of the electromagnetic carrier signal, wherein the query segment has a first logic level and the response segment has a second logic level, and wherein distinguishable points in time are defined by a signal change between adjacent query segments and response segments.

4. The method according to claim 1, wherein information encoded in the response segment is transmitted back to the base station in full-duplex.

5. The method according to claim 4, wherein the return data transmission takes place by a backscattering.

6. The method according to claim 1, wherein groups of transponders are selected.

7. The method according to claim 1, wherein the reference time is derived from a duration of an arbitration signal or from a duration of another symbol of the carrier signal.

8. The method according to claim 1, wherein the modulation points in time are calculated directly from the reference time through binary division of the reference time into equal time segments or by binary multiplication of the reference time, and wherein a different number of time segments and/or a different multiple of the time segments can be provided for different modulation points in time.

9. The method according to claim 8, wherein three equal time segments are provided for coding two distinguishable modulation points in time, and wherein each time segment corresponds to the reference time itself or to a binary multiple of the reference time.

10. The method according to claim 8, wherein three equal time segments, which are derived from the reference time by division, are provided for coding two distinguishable modulation points in time.

11. The method according to claim 8, wherein the reference time and the duration of an arbitration symbol are predefined by the base station so that, by dividing the reference time into four equal time segments, three of these time segments are used for coding the two distinguishable modulation points in time.

12. The method according to claim 1, wherein multiple arbitration symbols are provided, which have a substantially equal symbol duration.

13. The method according to claim 1, wherein a master/slave-based data communication between the base station and the transponder is provided in which the base station transmits the electromagnetic carrier signals onto which information packets are modulated, wherein each information packet has a header section, a middle section, and a trailer section, and wherein the header section is provided for controlling the data communication.

14. The method according to claim 13, wherein the reference time is transmitted in the header section.

15. The method according to claim 1, wherein the modulation is controlled by a counter or an analog time measurement unit.

16. The method according to claim 15, wherein the counter determines an end point of the modulation following a beginning of the modulation.

17. The method according to claim 15, wherein the counter is only active at a point in time of modulation for return data transmission, and is switched inactive once an end time point is reached.

18. The method according to claim 15, wherein the counter begins to count with a fixed, defined start time, and a current count state of the counter is continuously compared to additional reference durations which define the modulation time points, with the modulation being changed when the current count state of the counter reaches one of the additional reference durations.
